(19) United States
(12) Patent Application Publication
(10) Pub. No.: US 2009/0312060 A1
(43) Pub. Date: Dec. 17, 2009

(54) SYSTEM AND METHOD FOR INDICATING DATA TRANSFER RATE

(76) Inventors: L. Scott Bloebaum, Cary, NC (US); I. Nelson Wakefield, Cary, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 12/138,628

(22) Filed: Jun. 13, 2008

(51) Int. Cl. H04M 1/00

(52) U.S. Cl. 455/566; 455/550.1

(57) ABSTRACT

An electronic device provides a user with a direct and intuitive indication of achieved data transfer rates. In one embodiment, a vibrator is controlled to provide a tactile indication of upload and/or download speeds. Other embodiments relate to visual and/or audio indications of data transfer speed. Combinations of these indicators are also described.

### TECHNICAL FIELD OF THE INVENTION

The technology of the present disclosure relates generally to networking and, more particularly, to a system and method for indicating a data transfer rate of a wireless interface to a user of a portable electronic device.

### BACKGROUND

Mobile wireless electronic devices are becoming increasingly popular. For example, mobile telephones, portable media players and portable gaming devices are now in wide-spread use. In addition, the features associated with certain types of electronic devices have become increasingly diverse. To name a few examples, many electronic devices have cameras, text messaging capability, Internet browsing capability, electronic mail capability, video playback capability, audio playback capability, image display capability and handsfree headset interfaces.

The amount of data that many users transfer into or out of portable electronic devices has steadily increased. Radio technologies have made corresponding gains. For instance, second generation (2G) cellular network protocols such as global system for mobile communications (GSM) and general packet radio service (GPRS) are capable of attaining data transfer rates of about 50 kilobits per second (Kbps). 2.5G protocols (e.g., versions of GSM) are capable of attaining data transfer rates of about 150 Kbps. 3G protocols, exemplified by universal mobile telecommunications system (UMTS) and wideband code division multiple access (WCDMA), are capable of attaining data transfer rates of about 250 Kbps.

More recent high-speed, data-centric radio technologies are capable of achieving substantially higher data rates. For instance, high speed packet access (HSPA) and its family members, such as high speed downlink packet access (HSDPA), high speed uplink packet access (HSUPA) and evolved HSPA (HSPA+), are capable of achieving data transfer rates in the megabits per second (Mbps) range. For instance, HSDPA typically achieves downlink data transfer speeds of about one Mbps to about 7.2 Mbps, and a reported possible peak rate of about 14.4 Mbps. HSUPA typically achieves uplink data transfer speeds of about one Mbps to about two Mbps, and a reported possible peak rate of about 5.7 Mbps. These rates may be capped by service providers for operational reasons (e.g., most HSDPA compatible devices are configured to support up to 3.6 Mbps downlink speeds). Other current high speed technologies include various wireless local area network (WLAN) protocols, such as WiFi protocols consistent with any of the IEEE 802.11 standards, or WiMAX protocols consistent with any of the IEEE 802.16 standards.

Although the telecommunications industry is undergoing a transition from lower data transfer speeds to higher data transfer speeds, there have been minimal efforts to assist a user intuitively differentiate between conventional low data rate experiences and the faster data rate experiences that may be possible with newer technologies. The faster data rates are often advertised as “mobile broadband” or “broadband in your hand.” But most users are not aware of the improved data transfer rate performance when downloading or uploading data.

### SUMMARY

To enhance a user's experience with a portable electronic device, the present disclosure describes a number of techniques for providing the user with a direct and intuitive indication of achieved data transfer rates. In one embodiment, a vibrator is controlled to provide a tactile indication of upload and/or download speeds. Other embodiments relate to visual and audio indications of data transfer speed. Combinations of these indicators are also described.

According to one aspect of the disclosure, a first electronic device includes a wireless communications interface; a controller; and a vibrator, the vibrator controlled by the controller to vibrate as a function of a data transfer rate achieved over the wireless communications interface to provide tactile feedback of the data transfer rate.

According to an embodiment of the first electronic device, the data transfer rate is for one of a data uplink or a data downlink.

According to an embodiment of the first electronic device, the data transfer rate is for a data uplink.

According to an embodiment of the first electronic device, the data transfer rate is an aggregate data rate for a data downlink and a data uplink.

According to an embodiment of the first electronic device, the data transfer rate is a combined data transfer rate for plural wireless communications interfaces.

According to an embodiment of the first electronic device, a speed of vibrator actuation is proportional to the data transfer rate.

According to an embodiment of the first electronic device, an intensity of vibration caused by the vibrator is proportional to the data transfer rate.

According to an embodiment of the first electronic device, the vibrator is pulsed at a pulse rate that is proportional to the data transfer rate.

According to an embodiment of the first electronic device, the vibrator is pulsed and a length of the time that the vibrator is on relative to a duration of a pulse rate period is proportional to the data transfer rate.

According to an embodiment of the first electronic device, the vibrator is alternatively run at a first speed corresponding to a data downlink and a second speed corresponding to a data uplink.

According to an embodiment of the first electronic device, the vibrator is run at a first speed for a duration corresponding to a data transfer rate for a data downlink and a run at a second speed for a duration corresponding to a data transfer rate for a data uplink.

According to an embodiment of the first electronic device, the overall period of running at the first and second speeds corresponds to a total data transfer rate for the data downlink and the data uplink.

According to an embodiment, the first electronic device further includes a visual indicator device that is controlled by the controller to show an indication that the vibration relates to an appropriate one of a data transfer rate for a data downlink or a data transfer rate for a data uplink.

According to an embodiment of the first electronic device, the controller executes a data rate monitoring function to determine the data transfer rate.

According to an embodiment of the first electronic device, the data transfer rate is input to a tactile broadband function that is executed by the controller to output a control signal used by a vibration control function that is executed by the controller to control the vibrator.

According to another aspect of the disclosure, a second electronic device includes a wireless communications interface; a controller; and a visual indication device, the visual indication device controlled by the controller to present visual indicia to a user as a function of a data transfer rate achieved over the wireless communications interface to provide visual feedback of the data transfer rate.

According to an embodiment of the second electronic device, the visual indication device is one or more visible indicators that change color if the data transfer rate exceeds a predetermined threshold or flash as a function of the data transfer rate.

According to an embodiment of the second electronic device, the visual indication device is a plurality of visible indicators and a number of activated visible indicators is proportional to the data transfer rate.

According to another aspect of the disclosure, a third electronic device includes a wireless communications interface; a controller; and a speaker, the speaker controlled by the controller to output audio content to a user as a function of a data transfer rate achieved over the wireless communications interface to provide audio feedback of the data transfer rate.

According to an embodiment of the third electronic device, the audio content is a sound that has a pitch or a volume that is modified as a function of the data transfer rate.

According to an embodiment of the third electronic device, the audio content is pulsed in accordance with a pulse rate parameter that corresponds to the data transfer rate.

These and further features will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a schematic view of a mobile telephone as an exemplary electronic device that indicates data transfer speed to a user;

FIG. 2 is a schematic block diagram of the electronic device of FIG. 1;

FIG. 3 is a schematic diagram of a communications system in which the electronic device of FIG. 1 may operate; and

FIGS. 4-7 are exemplary graphs of vibrator actuation to represent data transfer speed to a user.

### DETAILED DESCRIPTION OF EMBODIMENTS

Embodiments will now be described with reference to the drawings, wherein like reference numerals are used to refer to like elements throughout. It will be understood that the figures are not necessarily to scale.

In the present document, embodiments are described primarily in the context of a mobile telephone. It will be appreciated, however, that the exemplary context of a mobile telephone is not the only operational environment in which aspects of the disclosed systems and methods may be used. Therefore, the techniques described in this document may be applied to any type of appropriate electronic device, examples of which include a mobile telephone, a media player, a gaming device, a computer, a pager, a communicator, an electronic organizer, a personal digital assistant (PDA), a smartphone, a portable communication apparatus, etc.

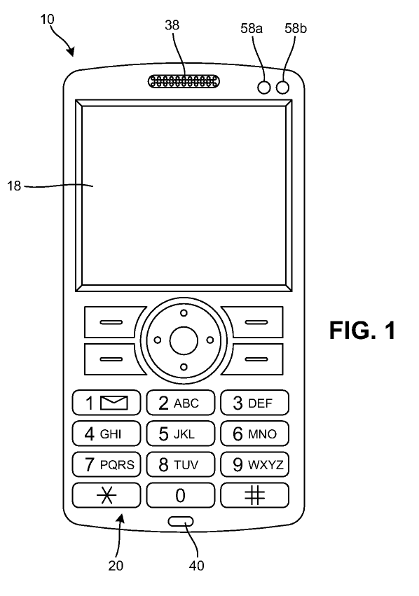

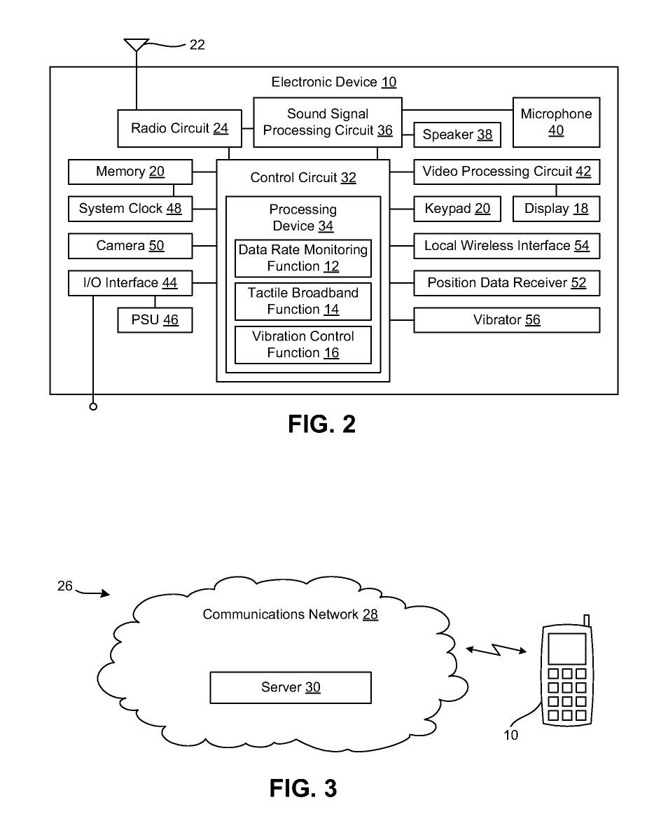

Referring initially to FIGS. 1 and 2, an electronic device is shown. The electronic device 10 includes a data rate monitoring function 12, a tactile broadband function 14 and a vibration control function 16 that are collectively configured to provide a tactile representation of data transfer speed to a user. Other embodiments that include an audio representation or a visual representation of data transfer rate may have coordinating control functions, such as an audio control function and a visual control function.

Additional details and operation of the various functions will be described in greater detail below. The functions may be embodied as executable code that is resident in and executed by the electronic device 10. In one embodiment, the functions may be one or more programs that are stored on a computer or machine readable medium. The functions each may be a stand-alone software application or form a part of a software application that carries out additional tasks related to the electronic device 10.

Also, through the following description, exemplary techniques for indicating data transfer rate are described. It will be appreciated that through the description of the exemplary techniques, a description of steps that may be carried out in part by executing software is described. The described steps are the foundation from which a programmer of ordinary skill in the art may write code to implement the described functionality. As such, a computer program listing is omitted for the sake of brevity. However, the described steps may be considered an algorithm that the corresponding device is configured to carry out.

The electronic device of the illustrated embodiment is a mobile telephone and will be referred to as the electronic device 10. The electronic device 10 may include a display 18. The display 18 displays information to a user such as operating state, time, telephone numbers, contact information, various menus, etc., that enable the user to utilize the various features of the electronic device 10. The display 18 also may be used to visually display content received by the electronic device 10 and/or retrieved from a memory 20 (FIG. 2) of the electronic device 10. The display 18 may be used to present images, video and other graphics to the user, such as photographs, mobile television content, Internet pages, and video associated with games. Also, in some embodiments, the display 18 may be used to display data transfer rate information to the user.

A keypad 20 provides for a variety of user input operations. For example, the keypad 18 may include alphanumeric keys for allowing entry of alphanumeric information (e.g., telephone numbers, phone lists, contact information, notes, text, etc.), special function keys (e.g., a call send and answer key, multimedia playback control keys, a camera shutter button, etc.), navigation and select keys or a pointing device, and so forth. Keys or key-like functionality also may be embodied as a touch screen associated with the display 18. Also, the display 18 and keypad 20 may be used in conjunction with one another to implement soft key functionality.

The electronic device 10 includes communications circuitry that enables the electronic device 10 to establish a communications with another device. Communications may include calls, data transfers, and the like. Calls may take any suitable form such as, but not limited to, voice calls and video calls. The calls may be carried out over a cellular circuit-switched network or may be in the form of a voice over Internet Protocol (VOIP) call that is established over a packet-switched capability of a cellular network or over an alternative packet-switched network (e.g., WiFi or WiMAX), for example. Data transfers may include, but are not limited to, receiving streaming content (e.g., streaming audio, streaming video, etc.), receiving data feeds (e.g., pushed data, podcasts, really simple syndication (RSS) data feeds data feeds), downloading and/or uploading data (e.g., image files, video files, audio files, ring tones, Internet content, etc.), receiving or sending messages (e.g., text messages, instant messages, electronic mail messages, multimedia messages), and so forth. This data may be processed by the electronic device 10, including storing the data in the memory 20, executing applications to allow user interaction with the data, displaying video and/or image content associated with the data, outputting audio sounds associated with the data, and so forth.

In the exemplary embodiment, the communications circuitry may include an antenna 22 coupled to a radio circuit 24. The radio circuit 24 includes a radio frequency transmitter and receiver for transmitting and receiving signals via the antenna 22.

With additional reference to FIG. 3, the radio circuit 24 may be configured to operate in a mobile communications system 26. Radio circuit 24 types for interaction with a mobile radio network and/or broadcasting network include, but are not limited to, global system for mobile communications (GSM), code division multiple access (CDMA), wideband CDMA (WCDMA), general packet radio service (GPRS), WiFi, WiMAX, digital video broadcasting-handheld (DVB-H), integrated services digital broadcasting (ISDB), HSPA, etc., as well as advanced versions of these standards or any other appropriate standard. It will be appreciated that the electronic device 10 may be capable of communicating using more than one standard. Therefore, the antenna 22 and the radio circuit 24 may represent one or more than one radio transceiver.

The system 26 may include a communications network 28 having a server 30 (or servers) for managing calls placed by and destined to the electronic device 10, transmitting data to and receiving data from the electronic device 10 and carrying out any other support functions. The server 30 communicates with the electronic device 10 via a transmission medium. The transmission medium may be any appropriate device or assembly, including, for example, a communications base station (e.g., a cellular service tower, or “cell” tower), a wireless access point, a satellite, etc. The network 28 may support the communications activity of multiple electronic devices 10 and other types of end user devices. As will be appreciated, the server 30 may be configured as a typical computer system used to carry out server functions and may include a processor configured to execute software containing logical instructions that embody the functions of the server 30 and a memory to store such software. In alternative arrangements, the electronic device 10 may wirelessly communicate directly with another electronic device 10 (e.g., another mobile telephone or a computer) and without an intervening network.

The electronic device 10 may include a primary control circuit 32 that is configured to carry out overall control of the functions and operations of the electronic device 10. The control circuit 32 may include a processing device 34, such as a central processing unit (CPU), microcontroller or microprocessor. The processing device 34 executes code stored in a memory (not shown) within the control circuit 32 and/or in a separate memory, such as the memory 20, in order to carry out operation of the electronic device 10. The memory 20 may be, for example, one or more of a buffer, a flash memory, a hard drive, a removable media, a volatile memory, a non-volatile memory, a random access memory (RAM), or other suitable device. In a typical arrangement, the memory 20 may include a non-volatile memory for long term data storage and a volatile memory that functions as system memory for the control circuit 32. The memory 20 may exchange data with the control circuit 32 over a data bus. Accompanying control lines and an address bus between the memory 20 and the control circuit 32 also may be present.

In addition, the processing device 34 may execute code that implements the data rate monitoring function 12, the tactile broadband function 14 and the vibration control function 16. It will be apparent to a person having ordinary skill in the art of computer programming, and specifically in application programming for mobile telephones or other electronic devices, how to program a electronic device 10 to operate and carry out logical functions associated with these functions. Accordingly, details as to specific programming code have been left out for the sake of brevity. Also, while the functions are executed by the processing device 34 in accordance with an embodiment, such functionality could also be carried out via dedicated hardware or firmware, or some combination of hardware, firmware and/or software.

The electronic device 10 further includes a sound signal processing circuit 36 for processing audio signals transmitted by and received from the radio circuit 24. Coupled to the sound processing circuit 36 are a speaker 38 and a microphone 40 that enable a user to listen and speak via the electronic device 10. The radio circuit 24 and sound processing circuit 36 are each coupled to the control circuit 32 so as to carry out overall operation. Audio data may be passed from the control circuit 32 to the sound signal processing circuit 36 for playback to the user. The audio data may include, for example, audio data from an audio file stored by the memory 20 and retrieved by the control circuit 32, or received audio data such as in the form of voice communications or streaming audio data from a mobile radio service. The sound processing circuit 36 may include any appropriate buffers, decoders, amplifiers and so forth.

The display 18 may be coupled to the control circuit 32 by a video processing circuit 42 that converts video data to a video signal used to drive the display 18. The video processing circuit 42 may include any appropriate buffers, decoders, video data processors and so forth. The video data may be generated by the control circuit 32, retrieved from a video file that is stored in the memory 20, derived from an incoming video data stream that is received by the radio circuit 24 or obtained by any other suitable method.

The electronic device 10 may further include one or more input/output (I/O) interface(s) 44. The I/O interface(s) 44 may be in the form of typical mobile telephone I/O interfaces and may include one or more electrical connectors. The I/O interfaces 44 may form one or more data ports for connecting the electronic device 10 to another device (e.g., a computer) or an accessory (e.g., a personal handsfree (PHF) device) via a cable. Further, operating power may be received over the I/O interface(s) 44 and power to charge a battery of a power supply unit (PSU) 46 within the electronic device 10 may be received over the I/O interface(s) 44. The PSU 46 may supply power to operate the electronic device 10 in the absence of an external power source.

The electronic device 10 also may include various other components. For instance, a system clock 48 may clock components such as the control circuit 32 and the memory 20. A camera 50 may be present for taking digital pictures and/or movies. Image and/or video files corresponding to the pictures and/or movies may be stored in the memory 20. A position data receiver 52, such as a global positioning system (GPS) receiver, Galileo satellite system receiver or the like, may be involved in determining the location of the electronic device 10. A local wireless interface 54, such as an infrared transceiver and/or an RF transceiver (e.g., a Bluetooth chipset) may be used to establish communication with a nearby device, such as an accessory (e.g., a PHF device), another mobile radio terminal, a computer or another device.

The electronic device 10 may further include a vibrator 56. Activation of the vibrator 56 may be controlled by the vibration control function 16. For instance, if the electronic device 10 receives an incoming telephone call and the user has set the electronic device 10 to vibrate when a call is received, the vibration control function 16 may activate the vibrator 56. Activation of the vibrator 56 may cause shaking of the electronic device 10 that may be felt by the user.

The type of vibrator is not directly germane to the disclosed techniques for indicating data transfer rate to a user of the electronic device 10. However, in the exemplary embodiments that are described below, the vibrator 56 may be an assembly having a motor that rotates a shaft. A weight may be eccentrically mounted to the shaft so that when the motor is driven to rotate the shaft, the corresponding movement of the weight causes the electronic device 10 as a whole to vibrate. Other types of vibrators are possible. For example, the vibrator 56 may be a piezoelectric vibrator.

The electronic device 10 may use the vibrator 56 to provide a tactile indication of data transfer performance. The tactile indication may be used to indicate download speed performance, upload speed performance, or both. For instance, the speed, intensity and/or a pulse repetition pattern (e.g., frequency of vibration bursts and/or duty cycle of vibration bursts) may be changed in accordance with downlink performance, uplink performance, or both. For instance, as the data rate increases, the speed of the vibration may increase proportionally. Other exemplary ways of controlling the vibrator 56 in accordance with data transfer speed will be described below. In this manner, the user may be provided with feedback that is indicative of current data transfer rate performance. In one embodiment, limits on the speed, intensity and/or vibration pulse rate may be used to minimize excessive vibration of the electronic device 10 that may otherwise cause discomfort to a user.

In the illustrated implementation, the data rate monitoring function 12 may determine at least one data rate value for at least one wireless interface (e.g., a WiMAX interface, an HSDPA interface, an HSUPA interface, or other interface). The data rate value may be one or more of the following: an instantaneous downlink data rate value, a time-averaged downlink data rate value, an instantaneous uplink data rate value, a time-averaged uplink data rate value, an instantaneous aggregate data rate value for the uplink and the downlink, or a time-averaged aggregate data rate value for the uplink and the downlink. Each data rate value may be indicative of the number of data bits per second flowing into and/or out of the electronic device 10 over the corresponding interface. Also, data rate values for more than one wireless interface (e.g., all interfaces or selected interfaces) may be combined (e.g., summed) to construct additional data rate values, such as an aggregate downlink data rate, an aggregate uplink data rate and/or an overall total data rate for all downlink and uplink interfaces.

Each determined data rate value may be updated at predetermined intervals. Therefore, data rate feedback that is output by the electronic device 10 may be current to the most recent update of the corresponding data rate value(s).

Each data rate value that is determined by the data rate monitoring function 12 and for which feedback is desired may be input to the tactile broadband function 14. In turn, the tactile broadband function 14 may generate an input control signal to the vibration control function 16. As will be appreciated, applications executed by the control circuit 32 may have control access to the vibrator 56 through the vibration control function 16.

The control signal generated by the tactile broadband function 14 causes the vibration control function 16 to activate the vibrator 56 in accordance with the control signal. The control signal may be generated, therefore, as a function of the data rate value or values input to the tactile broadband function 14 so that the resulting vibration is indicative of relative data transfer rate. The control signal may dictate whether the vibrator 56 should be on or off. Also, for times when the vibrator should be on, the control signal may dictate the speed or intensity of the vibrator 56. Depending on the vibrator 56, intensity may be related to speed of the vibrator 56.

In embodiments where the vibrator 56 is implemented as a motor driven weight, the speed of the vibrator 56 may be expressed as a function of the rotational speed of the motor, such as a rotations per second (RPS). Other type of vibrators may have speed measured in other manners. For instance, speed of piezoelectric vibrators may be expressed as a frequency. The frequency of the shaking of the electronic device 10 as a whole may be a function of the speed of the vibrator 56 and may depend on harmonics that result from the mechanical arrangement of the vibrator 56 with respect to the remainder of the electronic device 10.

Generation of the control signal by the tactile broadband function 14 may be enabled or disabled in any appropriate manner. For instance, in addition to default settings as to when to provide feedback regarding data transfer rate, the user may be provided with menu options to control whether or not to activate the vibrator 56 to provide feedback regarding data transfer rate. Each data-centric application may be associated with control options. For example, the feedback may be turned on or off for downloading music or other data downloads, may be turned on or off for data uploads, may be turned on or off for Internet browsing, etc.

The vibrator 56 may be controlled in a number of ways to represent one or more data transfer rate vales. Various exemplary ways to represent one or more data transfer rate values now will be described. It will be appreciated that there may be additional ways of representing one or more data transfer rate values. Also, the described approaches may be combined to provide desired feedback perception to the user. In addition, it will be appreciated that the feedback need not be provided over the entire time period during which data is transferred. For instance, feedback may be provided at the beginning and/or end of the data transfer, and at select intervals for long data transfers.

In one embodiment, the speed of vibration may be proportional to the data rate value for which feedback is desired. For instance, there may be a linear or nonlinear relationship between vibrator 56 speed and data rate so that, as data rate increases, the vibrator 56 speed increases. In another approach, there may be a predetermined number of speeds, such as a low speed, a medium speed and a high speed. When the data transfer rate is below a first threshold (e.g., about 250 kbps), the vibrator may be run at the low speed. When the data transfer rate is above the first threshold and below a second threshold (e.g., about 1 Mbps), the vibrator may be run at the medium speed. When the data transfer rate is above the second threshold, the vibrator may be run at the high speed. It will be appreciated that there may be more than or less than three speeds. In the embodiment where the vibrator 56 is a motor driven weight, speed of the vibrator (e.g., as measured in RPS) may depend on the amount of voltage applied to the motor. Exemplary speeds for this type of vibrator 56 may be about 40 RPS, 80 RPS and 120 RPS. In the embodiment of changing speed of the vibrator 56 to indicate data transfer rate, the vibrator 56 may be run continuously during a time in which feedback is provided or may be pulsed, such as a with a fixed pulse frequency.

Instead of changing speed to indicate data transfer rate, the intensity of vibration may be changed to indicate data transfer rate. But, for some vibrators, speed and intensity are related. Therefore, changing speed also may change intensity.

Also, rotational speed describes operation of a vibrator that is implemented as a motor driven weight. Other vibrators may be operated at an oscillation frequency. Therefore, since motor speed is a measure of rotational frequency and oscillation frequency is a measure of operational speed for other types of vibrators, the term “speed” may be thought of as a measure of how fast a vibrator is operated regardless of vibrator type.

The change in speed and/or intensity is described in the context of providing feedback of one data rate value, such as an aggregate uplink and downlink data rate for a selected interface, an uplink data rate for a selected interface, or a downlink data rate for a selected interface. In still other embodiments, an indication of downlink speed may be alternated with an indication of uplink speed.

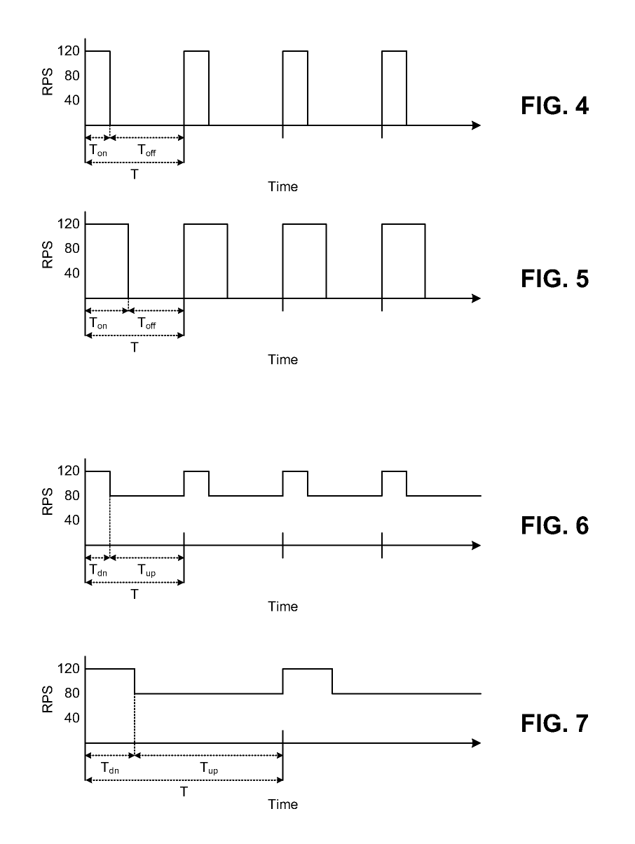

In other embodiments, data transfer rate may be indicated using variables associated with pulses of the vibrator 56. For instance, with additional reference to FIGS. 4 and 5, the vibrator 56 may be pulsed at a predetermined pulse rate with a period length T. FIGS. 4 and 5 graph vibrator 56 speed versus time. Exemplary lengths of the period T are about a quarter second, a half second and a second. During each period, the vibrator 56 may be turned on for an amount of time (Tₒₙ) that corresponds to the data rate. During the remainder of the period (T_{off}) the vibrator may be off. As such, the pulsing of the vibrator 56 has a duty cycle that is a function of the data rate. The duty cycle is the percentage of the period T that the vibrator is on. In one embodiment, the duty cycle is short (e.g., about 10 percent to about 25 percent) for slow data rates (e.g., about 250 Kbps or less), longer for moderate data rates (e.g., about a 25 percent to about a 40 percent duty cycle for data rates between 250 Kbps and 1 Mbps) and even longer for fast data rates (e.g., about 50 percent or more for data rates over 1 Mbps).

During each pulse, the vibrator 56 may be driven with a predetermined speed and/or intensity. In other embodiments, the speed and/or intensity may be varied to indicate another data transfer parameter. For instance, one speed may be used to indicate downlink speed and another speed may be used to indicate uplink speed. In one embodiment, a series of pulses (e.g., about two to ten pulses) may be used to indicate downlink speed and the pulses may be followed by a series of pulses (e.g., about two to ten pulses) to indicate uplink speed. In another approach, pulses to indicate downlink and uplink speeds may be alternated.

In the embodiment of FIGS. 4 and 5, the pulse rate (or period T) is constant. In other embodiments, the pulse rate may be changed to indicate relative data transfer speed. In this embodiment, the duty cycle may be fixed (e.g., about fifty percent) or may be variable. As one example, a shorter period (e.g., about a tenth of second to about a quarter of second) may indicate a relatively fast data transfer rate (e.g., a data rate of over about one Mbps) and a relatively longer period (e.g., about a half second to about one second) may indicate a relative slow data transfer rate (e.g., a data rate of less than about one Mbps). Similar to the embodiment where the period T is fixed, the speed and/or intensity may be fixed or may be variable to indicate a data transfer parameter.

In still other embodiments, additional sensory feedback may be provided in conjunction with use of the vibrator. For instance, visual indicators and/or audio may be used to present information to the user. In one embodiment, during indication of downlink speed using one of the tactile feedback approaches, a corresponding icon or graphic may be displayed on the display 18 and, during indication of uplink speed using one of the tactile feedback approaches, a corresponding icon or graphic may be displayed on the display 18. As one example, during tactile indication of downlink speed, a down arrow or the word “down” may be displayed on the display 18. Similarly, during tactile indication of uplink speed, an up arrow or the word “up” may be displayed on the display 18. Also, the displayed content may be made larger or smaller depending on a corresponding data transfer rate and/or may be made to pulse (e.g., flash) in coordination with any pulsing of the vibrator 56. Other examples of displayed content may be graphic representations of content flowing from the electronic device 10 and/or to the electronic device 10.

In still other embodiments, one or more illumination devices (e.g., light emitting diodes or LEDs 58) may be used in conjunction with the tactile indication of data transfer speed. For instance, one LED 58a may illuminate when providing feedback for the downlink speed and another LED 58b may illuminate when providing feedback for the uplink speed. In another embodiment, one LED 58 may illuminate with a first color (e.g., one of red, yellow or green) during the tactile indication of the downlink speed and the LED 58 may illuminate with a second color (e.g., another one of red, yellow or green) during the tactile indication of the uplink speed. Also, the appropriate LED 58 may be made to pulse (e.g., flash) in coordination with any pulsing of the vibrator 56.

With additional reference to FIGS. 6 and 7, variations in pulse cycle attributes may be used to indicate downlink data transfer rate and uplink data transfer rate. Similar to FIGS. 4 and 5, FIGS. 6 and 7 graph vibrator 56 speed versus time. In the illustrated embodiment, the operation of the vibrator has a pulse period length T that is a function of one of the downlink data transfer rate or the uplink data transfer rate, or both. During a portion of the period, the vibrator 56 is operated at a first speed that corresponds to the downlink and then a second speed that corresponds to the uplink. The length of time and/or the percentage of the period T that the vibrator 56 operates at the different speeds respectively indicate the downlink data rate and the uplink data rate.

In the illustrated example, the downlink is associated with a higher speed (e.g., 120 RPS) and the uplink is associated with a lower speed (e.g., 80 RPS). The duration of the vibration at the higher speed is denoted by T_{dn} and the duration of the vibration at the lower speed is denoted by Tᵤₚ. In the graph of FIG. 6, the downlink and uplink data transfer rates are relatively low compared to the downlink and uplink data rates for the graph of FIG. 7. Therefore, in the illustrated example, the period T and the lengths of T_{dn} and Tᵤₚ may be elongated as data rates increase, where the total length is proportional to the aggregate uplink and downlink data rates.

As a more specific example, the graph of FIG. 6 shows a period T of about one second, where T_{dn} is about a quarter of a second to represent a downlink data rate of about 1 Mbps and Tᵤₚ is about three quarters of a second to represent an uplink data rate of about 100 kbps. If operation improves (e.g., an increase in downlink speed to about two to three Mbps and an increase in uplink speed to about 500 kbps), the various attributes of the pulsing may be lengthened as show in FIG. 7. In this illustrated example, the period T increased to about two seconds, the length of T_{dn} increased to about half a second, and the length of Tᵤₚ increased to about one and a half seconds. In effect, the period T may lengthen as data rate performance increases, but a higher percentage of the period T is dedicated to the slower of the downlink or uplink data rates.

In another embodiment, the period T may lengthen as data rate performance increases, but a higher percentage of the period T is dedicated to the faster of the downlink or uplink data rates.

In another embodiment, the period T (and, if desired, the percentage of the period T dedicated to T_{dn}) may be decreased as data rates increase. This embodiment may provide the user with a “furious” feeling to the vibration that imparts an impression of fast operation. In contrast, the embodiment of extending the period T for faster aggregate data rate may impart more discernable information regarding data transfer performance.

In any of these embodiments, the percentage of the period T dedicated to T_{dn} may have a linear relationship or a nonlinear relationship to the ratio of the downlink data rate to the uplink data rate.

Regardless of the specific relationships between data transfer rates and the length of the period T, the percentage of the period T dedicated to the vibrator speed associated with downlink performance, and the percentage of the period T dedicated to the vibrator speed associated with uplink performance, the basic principle is that the speed (e.g., frequency) of the vibrator 56 is toggled between two speeds for respective periods of time that relate to downlink speed and uplink speed. For instance, the length of the period (period T) may relate to aggregate data rate and the duty cycle dedicated to the downlink speed may be based on the relative downlink and uplink rates.

As indicated, feedback regarding data transfer rate may be provided to the user using visual and/or audio techniques. For instance, one or more of the LEDs 58 may be flashed at a rate that is indicative of data rate performance. Any of the foregoing techniques for pulsing the vibrator 58 may be applied to the flashing of the LED(s) 58. For instance, the length of each flash cycle may decrease as data transfer rate increases.

In another embodiment, there may be a series of LEDs 58 (e.g., about three LEDs to about ten LEDs). The number of illuminated LEDs 58 may increase in correspondence to the speed of data transfer. For instance, one or two LEDs 58 may illuminate for data rates less than 250 Kbps. Three or four LEDs 58 may illuminate for data rates between 250 Kbps and one Mbps. Five LEDs 58 may illuminate for a data rate of over one Mbps and one addition LED 58 may illuminate for each additional half Mbps in performance beyond one Mbps.

In another embodiment, the LED(s) 58 may change color based on the data rate value of interest. For instance, for a data rate of less than one Mbps, the LED 58 may illuminate with a first color (e.g., one of red, yellow or green) and, for a data rate of greater than one Mbps, the LED 58 may illuminate with a second color (e.g., another one of red, yellow or green). Also, a first LED (e.g., LED 58a in the illustrated embodiment) may change color based on downlink performance and a second LED (e.g., LED 58b in the illustrated embodiment) may change color based on uplink performance.

Other visual indicators of data rate performance that are presented on the display 18 are possible. Exemplary displayed indicators may include, but are not limited to, a graphic (e.g., a gauge that is akin to a speedometer, a moving cartoon character, etc.), a graph, a bar with a length that is proportional to the data rate, a series of symbols, text and/or numbers that quantify the data rate, a flashing symbol, etc. Color and/or changes in color, and/or flashing of displayed content, similar to any of the foregoing color changing or vibration pulsing techniques, may be used to impart data rate information. In another embodiment, a graphic (e.g., a cartoon character) may be made to move around the area of the display with a speed that has a relationship to the data rate. Alternatively, the size or length of displayed content may be used as indicator of a corresponding data rate value. In one embodiment, display content may have one appearance for a relatively low data transfer rate (e.g., below one Mbps), have another appearance for a typical broadband data rate (e.g., about one Mbps to about three Mbps) and have a third appearance during periods of even faster performance.

In other embodiments, data rate feedback may be presented as audio through the speaker 38 and/or a headset (not shown). The audio feedback may be in the form of a tone that changes in pitch (e.g., from low to high for increases in data rate and from high to low for decreases in data rate), changes in volume and/or pulsed on and off based on the corresponding data rate value. Pulsing of the tone may be carried out using any of the foregoing techniques for pulsing the vibrator 58. For instance, the length of each pulse cycle may decrease as data transfer rate increases.

In other embodiments, the audio may simulate another object. For instance, the audio may sound like the “revving” of a car engine where the simulated engine speed is proportional to the data rate value.

A number of techniques for indicating data transfer rates to a user of the electronic device 10 have been described. It will be appreciated that the use of one or more of these techniques may assist a user in seeking out locations at which relatively high data rates may be achieved. Also, the techniques leverage the handheld nature of many portable electronic devices to establish an interesting feature that allows the user to more fully comprehend the speed of data transfer.

Although certain embodiments have been shown and described, it is understood that equivalents and modifications falling within the scope of the appended claims will occur to others who are skilled in the art upon the reading and understanding of this specification.

What is claimed is:

1. An electronic device, comprising:
a wireless communications interface;
a controller; and
a vibrator, the vibrator controlled by the controller to vibrate as a function of a data transfer rate achieved over the wireless communications interface to provide tactile feedback of the data transfer rate.

2. The electronic device of claim 1, wherein the data transfer rate is for one of a data uplink or a data downlink.

3. The electronic device of claim 1, wherein the data transfer rate is an aggregate data rate for a data downlink and a data uplink.

4. The electronic device of claim 1, wherein the data transfer rate is a combined data transfer rate for plural wireless communications interfaces.

5. The electronic device of claim 1, wherein a speed of vibrator actuation is proportional to the data transfer rate.

6. The electronic device of claim 1, wherein an intensity of vibration caused by the vibrator is proportional to the data transfer rate.

7. The electronic device of claim 1, wherein the vibrator is pulsed at a pulse rate that is proportional to the data transfer rate.

8. The electronic device of claim 1, wherein the vibrator is pulsed and a length of the time that the vibrator is on relative to a duration of a pulse rate period is proportional to the data transfer rate.

9. The electronic device of claim 1, wherein the vibrator is alternatively run at a first speed corresponding to a data downlink and a second speed corresponding to a data uplink.

10. The electronic device of claim 1, wherein the vibrator is run at a first speed for a duration corresponding to a data transfer rate for a data downlink and a run at a second speed for a duration corresponding to a data transfer rate for a data uplink.

11. The electronic device of claim 10, wherein the overall period of running at the first and second speeds corresponds to a total data transfer rate for the data downlink and the data uplink.

12. The electronic device of claim 1, further comprising a visual indicator device that is controlled by the controller to show an indication that the vibration relates to an appropriate one of a data transfer rate for a data downlink or a data transfer rate for a data uplink.

13. The electronic device of claim 1, wherein the controller executes a data rate monitoring function to determine the data transfer rate.

14. The electronic device of claim 13, wherein the data transfer rate is input to a tactile broadband function that is executed by the controller to output a control signal used by a vibration control function that is executed by the controller to control the vibrator.

15. An electronic device, comprising:
a wireless communications interface;
a controller; and
a visual indication device, the visual indication device controlled by the controller to present visual indicia to a user as a function of a data transfer rate achieved over the wireless communications interface to provide visual feedback of the data transfer rate.

16. The electronic device of claim 15, wherein the visual indication device is one or more visible indicators that change color if the data transfer rate exceeds a predetermined threshold or flash as a function of the data transfer rate.

17. The electronic device of claim 15, wherein the visual indication device is a plurality of visible indicators and a number of activated visible indicators is proportional to the data transfer rate.

18. An electronic device, comprising:
a wireless communications interface;
a controller; and
a speaker, the speaker controlled by the controller to output audio content to a user as a function of a data transfer rate achieved over the wireless communications interface to provide audio feedback of the data transfer rate.

19. The electronic device of claim 18, wherein the audio content is a sound that has a pitch or a volume that is modified as a function of the data transfer rate.

20. The electronic device of claim 18, wherein the audio content is pulsed in accordance with a pulse rate parameter that corresponds to the data transfer rate.
